(19) United States
(12) Patent Application Publication
(10) Pub. No.: US 2003/0039713 A1
(43) Pub. Date: Feb. 27, 2003

(54) Soap machine

(76) Inventor: William Howard Turner, Montgomery, AL (US)

Correspondence Address: WILLIAM HOWARD TURNER, 231 ARLINGTON ROAD, MONTGOMERY, AL, 36105, US

(21) Appl. No.: 09/841,682

(22) Filed: Aug. 22, 2001

(51) Int. Cl. C11D 13/18

(52) U.S. Cl. 425/318; 425/417

(57) ABSTRACT

Making pieces of soap into one solid bar. After being rinsed and soaked in hot water for several minutes, the used pieces of soap are deposited into the center compartment of the soap machine, and depressed with the plunger until all of the water escapes from the solid bar into the other compartments and this water is discarded. Lift the containing walls on the soap machine and slid the spatula under and remove the solid soap bar.

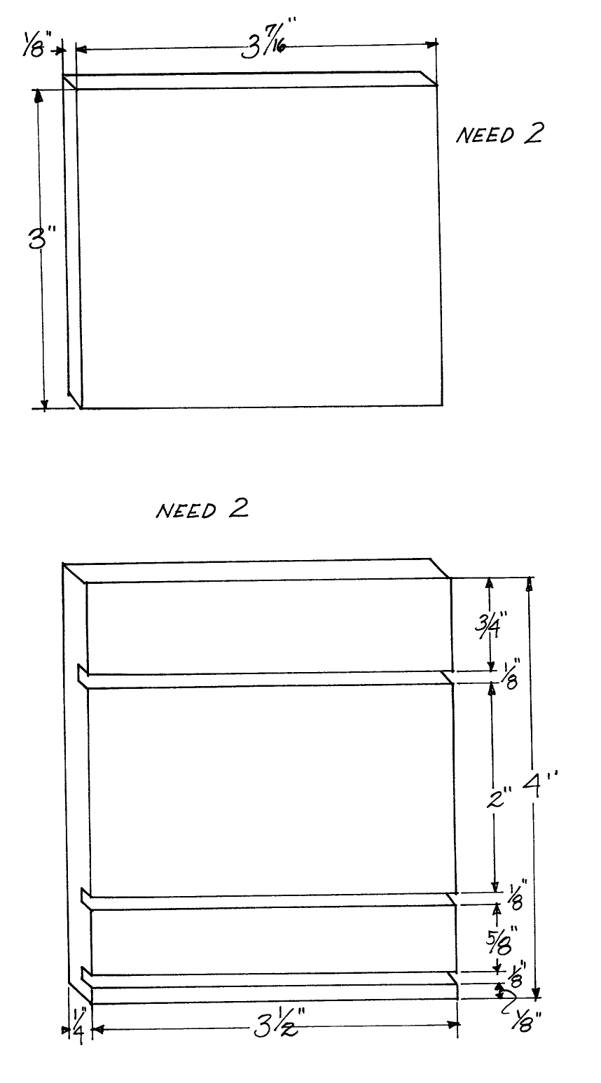

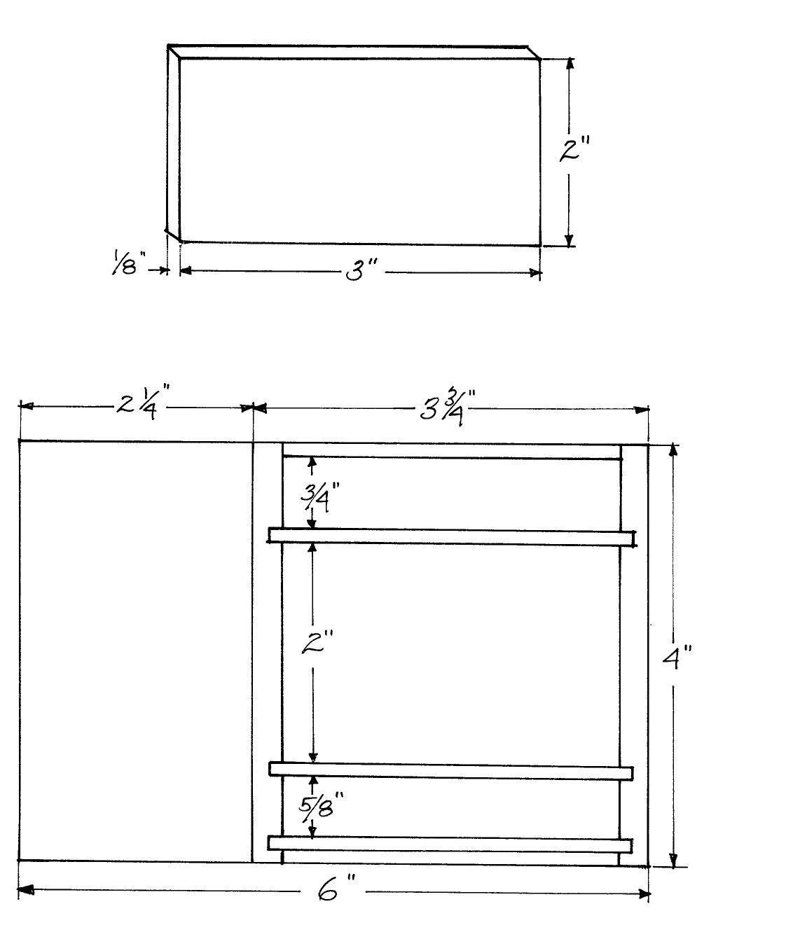

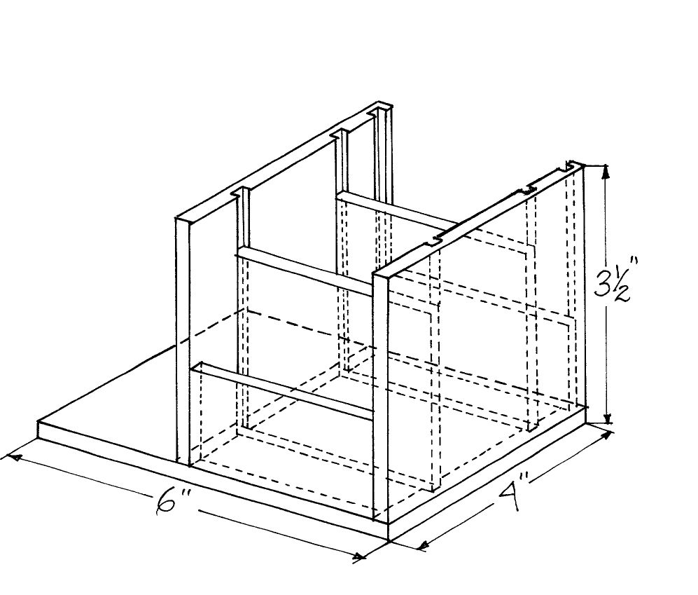

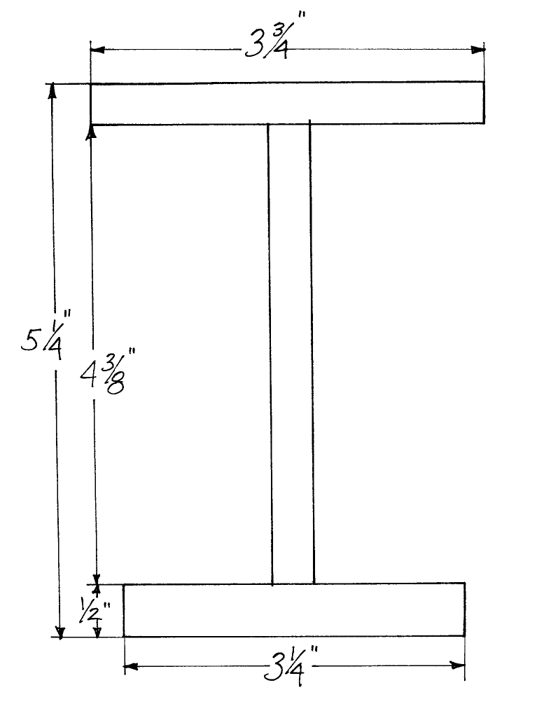

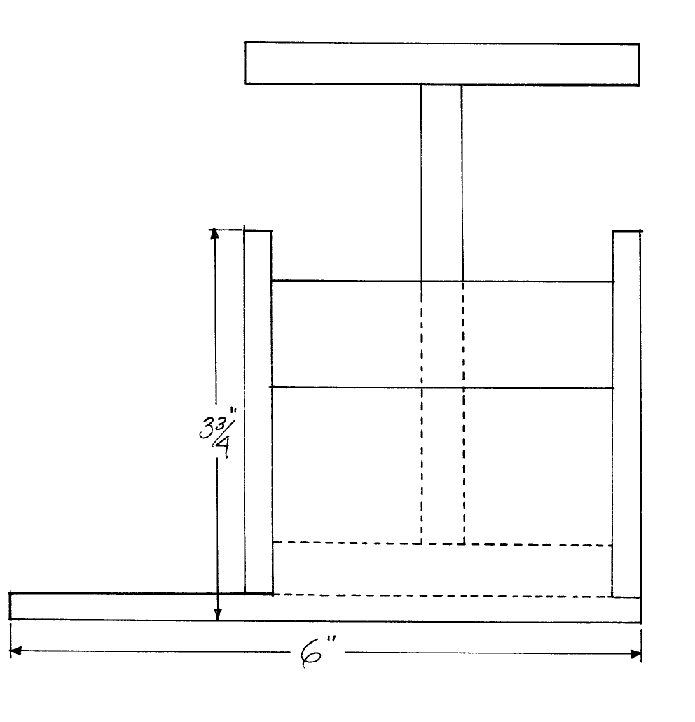

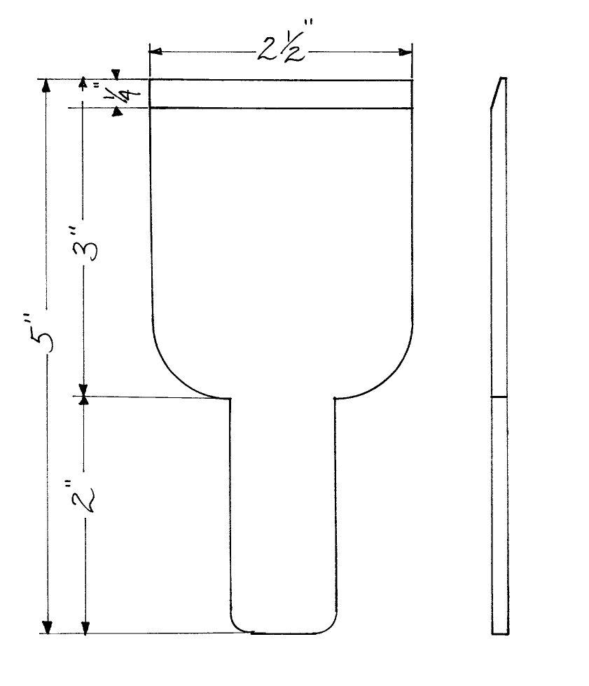

The Soap Machine is small device which interworkings measures about 4″×3¾″×4″, which will include a plunger and a spatula. The pilot version is made out of iron, but the marketing version to the public will be made out of plastic. The purpose of the Soap Machine is to recycle soap.

After using a bar of soap until it is too small to be effective, the small piece is saved, instead of being thrown away. When one has accumulated about 8 to 10 (you decide) small pieces, rinse the pieces and submerge them in hot water for about 10 to 15 minutes (depending on whether you have hard soap or soft soap). Next, deposit the pieces into the Soap Machine. Take the plunger and compress the pieces until it becomes one solid piece. Remove the soap (following the instructions) and let stand for a few minutes before using. For best results, use the same brand soap together.

1. What I claim as my invention is THE SOAP MACHINE. It is a device used to recycle soap. With this machine, one will accumulate pieces of soap, following instruction, put those pieces in the Soap Machine, and produce one solid bar of soap.
